(19) United States
(12) Patent Application Publication
(10) Pub. No.: US 2018/0075448 A1
(43) Pub. Date: Mar. 15, 2018

(54) ELECTRONIC EXCHANGE UNIT MANAGEMENT

(71) Applicant: KOOTORO, Inc., San Jose, CA (US)

(72) Inventor: Huan NGUYEN, San Jose, CA (US)

(21) Appl. No.: 15/262,352

(22) Filed: Sep. 12, 2016

(51) Int. Cl. G06Q 20/38; G06Q 20/40

(52) U.S. Cl. CPC G06Q 20/381; G06Q 20/40

(57) ABSTRACT

A device for managing exchange unit transfers between consumers and merchants includes a memory that stores machine instructions and a processor coupled to the memory that executes the machine instructions to direct a consumer payment from a financial account associated with the device to an exchange unit dispenser. The consumer payment is denominated in a national currency corresponding to a location associated with the device. The processor further executes the instructions to receive a balance of exchange units corresponding to an exchange account associated with the device. The balance of exchange units is based on the national currency and is greater than the consumer payment. The processor also executes the instructions to encode information associated with the device and transmit the encoded information to a merchant terminal.

### TECHNICAL FIELD

The present disclosure relates generally to electronic exchange media and, more particularly, to electronic exchange unit management.

### BACKGROUND

Exchange media are used to facilitate transfers of goods and services between individuals or entities. Traditionally, currency in the form of commodity, representative or fiat money has been used as a medium of exchange between private individuals and entities. While commodity money embodies materials having intrinsic value, and the value of representative money is similarly tied to underlying commodities, the value of fiat money is primarily based on governmental backing, warranties and the relationship between supply and demand with regard to its common use in trade.

For some time, money has been transferred between financial institutions through electronic clearinghouses. More recently, money has been transferred between individuals and other entities by means of online banking involving communications over the Internet. With the advent of smartphones, mobile payments consisting of electronic transfers of money between individuals and entities have been introduced. Mobile payments generally require electronic communication of price, payment and financial information between a mobile phone and a point-of-sale terminal.

### SUMMARY

According to one embodiment of the present invention, a device for managing exchange unit transfers between consumers and merchants includes a memory that stores machine instructions and a processor coupled to the memory that executes the machine instructions to direct a consumer payment from a financial account associated with the device to an exchange unit dispenser. The consumer payment is denominated in a national currency corresponding to a location associated with the device. The processor further executes the instructions to receive a balance of exchange units corresponding to an exchange account associated with the device. The balance of exchange units is based on the national currency and is greater than the consumer payment. The processor also executes the instructions to generate a matrix barcode encoding information associated with the device and display the matrix barcode.

According to another embodiment of the present invention, a terminal includes a non-transitory, computer-readable storage medium encoded with instructions adapted to be executed by a processor to implement directing a merchant payment from an exchange unit dispenser to a financial account associated with the terminal, the merchant payment denominated in a national currency corresponding to a location associated with the terminal. The instructions are further adapted to implement receiving a debit balance of exchange units corresponding to an exchange account associated with the terminal, the debit balance of exchange units being based on the national currency and being greater than the merchant payment. The instructions are also adapted to implement receiving an input including a price associated with goods and/or services, scanning a matrix barcode from a personal exchange device and decoding the matrix barcode to acquire information associated with the personal exchange device. The instructions are further adapted to implement decoding the matrix barcode to acquire information associated with the personal exchange device and receiving an authorization in response to the request.

According to yet another embodiment of the present invention, a computer-implemented method of managing exchange unit transfers between consumers and merchants includes directing a merchant payment to a financial account associated with a merchant terminal and debiting a number of exchange units to a merchant account associated with a merchant terminal. The method further includes receiving one or more consumer payments directed by one or more personal exchange devices and adding the number of exchange units to one or more consumer accounts associated with the one or more personal exchange devices. The one or more consumer payments total more than the merchant payment. The method also includes receiving at least one request associated with at least one tentative transaction associated with the merchant terminal and the one or more personal exchange devices. The method further includes deducting the number of exchange units from the one or more consumer accounts and crediting the number of exchange units to the merchant account in response to receiving the at least one request.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is a block diagram illustrating an exemplary exchange management system in accordance with an embodiment of the present invention.

FIG. 2 is a block diagram illustrating an exemplary personal exchange device that can be employed in the exchange management system of FIG. 1 in accordance with an embodiment of the present invention.

FIG. 3 is a block diagram illustrating an exemplary merchant terminal that can be employed in the exchange management system of FIG. 1 in accordance with an embodiment of the present invention.

FIG. 4 is a block diagram illustrating an exemplary exchange unit dispenser that can be employed in the exchange management system of FIG. 1 in accordance with an embodiment of the present invention.

FIG. 5 is a schematic view depicting an exemplary computing system that can implement the exchange management system of FIG. 1 in accordance with an embodiment of the present invention.

FIG. 6 is a flowchart representing an exemplary method of managing electronic exchange units to facilitate exchange unit disbursements in accordance with an embodiment of the present invention.

FIG. 7 is a flowchart representing an exemplary method of managing electronic exchange units to transfer exchange units between consumer accounts in accordance with an embodiment of the present invention.

FIG. 8 is a flowchart representing an exemplary method of managing electronic exchange units to facilitate point-of-sale (POS) exchanges between consumers and merchants in accordance with an embodiment of the present invention.

### DETAILED DESCRIPTION

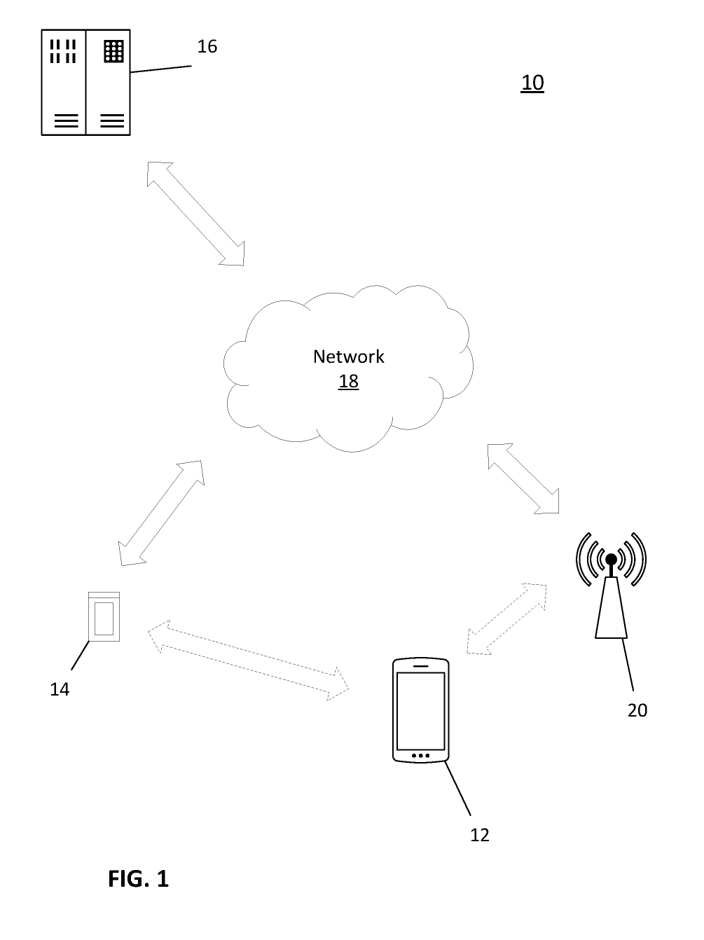

An embodiment of the present invention is shown in FIG. 1, which illustrates an exemplary exchange management system 10 that employs an electronic exchange unit management process in order to facilitate exchange unit disbursements, exchange unit transfers between individuals, and point-of-sale (POS) exchanges between consumers and merchants. The exchange management system 10 includes a personal exchange device 12, a merchant terminal 14 and an exchange unit dispenser 16.

The exchange management system 10 embodies a convenient digital cashless platform communicatively connected to a an international network of businesses. Consumers use the personal exchange device 12 to load or reload exchange units to a consumer account, transfer exchange units to other consumers, and carry out point-of-sale transactions with merchants to redeem the exchange units. Merchants and other business entities use the merchant terminal 14 to execute transactions with consumers involving the interchange of goods and/or services for exchange units. The personal exchange device 12 and the merchant terminal 14 interact with the exchange unit dispenser 16 to effect the distribution, transfer and interchange of exchange units.

The exchange management system 10 distributes and manages exchange units, which are currency-derived points that can be used in lieu of money to carry out financial transactions between individuals and business entities. Prospective purchasers, or consumers, acquire exchange units or vouchers in a consumer account using the personal exchange device 12 in connection with the exchange unit dispenser 16. The prospective purchasers use the personal exchange device 12 to make payment by way of the exchange management system 10 for the exchange units. For example, in an embodiment, prospective purchasers buy exchange units at a purchase discount. That is, the prospective purchasers receive a larger number of exchange units than the amount of payment provided in denomination of a national currency.

Merchants agree to provide or sell future goods and/or services to purchasers in exchange for the exchange units. The merchants accept payment by way of the exchange management system 10, or an entity that operates the exchange management system 10, in exchange for a promise to provide an agreed future value of goods and/or services. A merchant account in connection with the exchange unit dispenser 16 is debited the number of exchange units equal to the future value of the goods and/or services. For example, in an embodiment, merchants sell future goods and/or services at a sales discount. That is, the merchants agree to provide a larger future value of goods and/or services than the amount of payment received in denomination of a national currency.

The future value is determined at the price the goods and/or services are offered to the general public by the merchant at the time of the individual future consumer transactions by which the goods and/or services are ultimately provided to the prospective purchasers. The price may correspond to the regular price structure of the merchant in effect at the time of the transactions, or a special price offered by the merchant at the time of the transactions, for example sale or coupon prices.

At the time of the purchase and sale transactions between the purchasers and merchants, the personal exchange device 12 and the merchant terminal 14 communicate with each other and with the exchange unit dispenser 16 to deduct exchange units from the respective consumer accounts and credit the respective merchant accounts. In an embodiment, the rate of the sales discount provided by the merchant is greater than the rate of the purchase discount received by the purchasers. The difference between the discount rates can provide a profit to the entity that operates the exchange management system 10.

In various embodiments, the personal exchange device 12, the merchant terminal 14 and the exchange unit dispenser 16 can be coupled to a communication network 18. In some embodiments, a transmission point (TP) 20, or cell tower, receives and transmits communications between the personal exchange device 12 and the communications network 18.

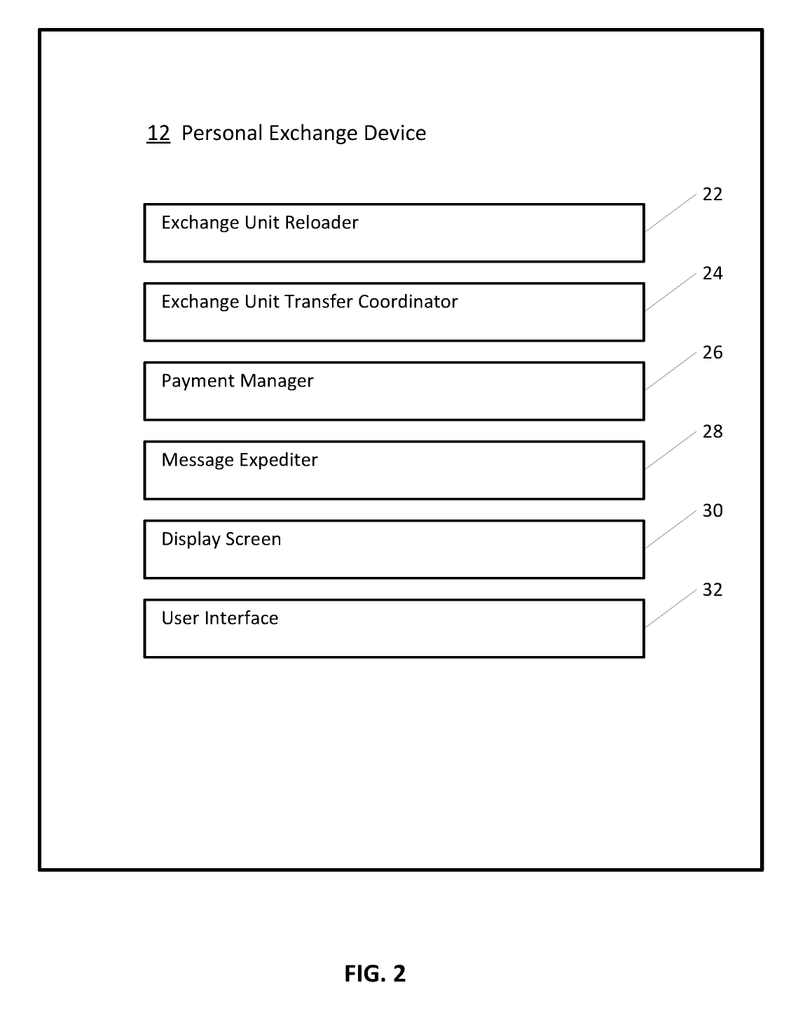

Referring to FIG. 2, an exemplary personal exchange device 12 includes an exchange unit reloader 22, an exchange unit transfer coordinator 24, a payment manager 26 and a message expediter 28, a display screen 30 and a user interface (UI) 32. The exchange unit reloader 22 provides a user, or consumer, with an interface for acquiring exchange units. The user pays for the exchange units with the local national currency, or base currency, where the user has a registered account with the exchange management system 10. For example, the exchange unit reloader 22 may direct or order payment from a debit or credit card to a financial account connected with the exchange management system 10. The exchange units are credited to the registered account and are immediately available for use in other transactions.

The exchange units are credited in the denomination of the national currency where the user account is registered. However, the cost of acquiring exchange units may not be equivalent to the face value of the number of exchange units. For example, the payment in national currency required for the exchange units may be less than the number of exchange units acquired. The purchasing power, or value, of the exchange units at participating merchants is equal to the local national currency. Thus, the value of the exchange units, or points, is derived from a national currency, although the cost of each exchange unit may differ from a unit of national currency.

In an embodiment, the user may make payment for the exchange units in cash at a participating merchant store. In addition, a currency balance may be transferred from a physical gift card at a participating merchant store and converted into exchange units. The exchange unit reloader 22 may store a default payment method, such as a debit or credit card number, for use in reload operations. The exchange unit reloader 22 may enforce a minimum or maximum number of exchange units per reload operation. The exchange unit reloader 22 may include an automated feature that reloads a preset number of exchange units without requiring manual user input whenever the consumer account balance reaches a predetermined minimum balance value.

The exchange unit transfer coordinator 24 provides the user with an interface for sending exchange units to another account managed by the exchange management system 10. The exchange units are available for use as soon as the exchange unit transfer coordinator 24 has completed the transfer. For example, in an embodiment, the exchange unit transfer coordinator 24 directs or coordinates the transfer of exchange units from one consumer account to another consumer account registered by the same user with the exchange management system 10.

In another embodiment, the exchange unit transfer coordinator 24 directs the transfer of exchange units from a consumer account to another consumer account registered by a different user with the exchange management system 10. For example, a user may send exchange units to a friend or family member that has an account with the exchange management system 10 or conduct financial transactions with another individual that has an account with the exchange management system 10. In yet another embodiment, the exchange unit transfer coordinator 24 directs the transfer of exchange units from a consumer account in the local currency to another consumer account registered in a different national currency with the exchange management system 10.

In an embodiment, the exchange unit transfer coordinator 24 sends a notification, for example, in the form of an electronic or virtual gift card, on behalf of the user to another individual. The receiving individual may or may not currently have an account with the exchange management system 10. For example, the notification may be sent by email to an email address or by short message service (SMS) to a text-capable phone number.

The virtual card may include a format based on a predesigned template and include a personal message from the sender. The amount sent may be limited by a minimum or maximum number of exchange units. In the case that the receiving individual does not currently have a registered consumer account with the exchange management system 10, the receiver may be required to open an account before the exchange units may be transferred. Otherwise, the email notification may provide instructions for printing the gift card including a unique identification number for presentation at a participating merchant store.

The payment manager 26 provides the user with an interface for transacting purchases using the exchange units in place of money to carry out financial transactions between individuals and business entities. In an embodiment, the payment manager 26 generates and displays a matrix barcode, such as a two-dimensional barcode or QR Code®, that can be read by a scanner. The payment manager 26 includes information in the matrix barcode that permits exchange units in a specified consumer account to be exchanged as payment for goods or services from a merchant. Thus, the payment manager 26 allows the exchange units to be used as payment for goods or services. In an embodiment, the payment manager 26 requires manual input of a personal identification number (PIN) to generate the matrix barcode or initiate a purchase transaction.

In an embodiment, the matrix barcode includes a randomized, two-dimensional machine-readable optical label that contains payment information, such as a QR Code identifier, in a standardized encoding mode, for example, a numeric, alphanumeric or binary code. The encoding mode may utilize error code correction (ECC). QR Codes include distinctive square patterns at three corners of the QR code image, as well as a smaller square near the fourth corner to normalize the image for size, orientation, and angle of viewing. The information is represented by a square matrix of small, square dots, for example, a 21×21 dot matrix, a 57×57 dot matrix, a 177×177 dot matrix, or any other suitable size dot matrix.

An example matrix barcode may include payment information, such as a payment descriptor, including, for example, an input mode (or data type), maximum number of characters, number of bits per character, and specific character representations. For example, the input modes may include numeric, alphanumeric or binary (byte). The payment information may include, for example, an identifier for a financial account, payment amount, currency code, reference number, recipient name, a username, shipping address, billing address, street address, telephone number, email address, date, payment type, description, and message for the recipient.

The message expediter 28 prepares and sends text-based messages, for example, by way of an email or short message service (SMS) protocol. The display screen 30 provides a visual mechanism by which the personal exchange device 12 is able to communicate with the user. The user interface (UI) 32 provides visual, audio, tactile or other interface tools by which the user is able to communicate with the personal exchange device 12. In an embodiment, the personal exchange device 12 includes an internet-capable, application-ready mobile phone, such as a smartphone, and a mobile application program that implements the exchange unit transfer coordinator 24, the payment manager 26, the message expediter 28 and the user interface (UI) 32. In another embodiment, the personal exchange device 12 includes a personal computer (PC) and a web application program that implements the exchange unit transfer coordinator 24, the payment manager 26, the message expediter 28 and the user interface (UI) 32. In some embodiments, the application program may be accessed only with a personal identification number (PIN).

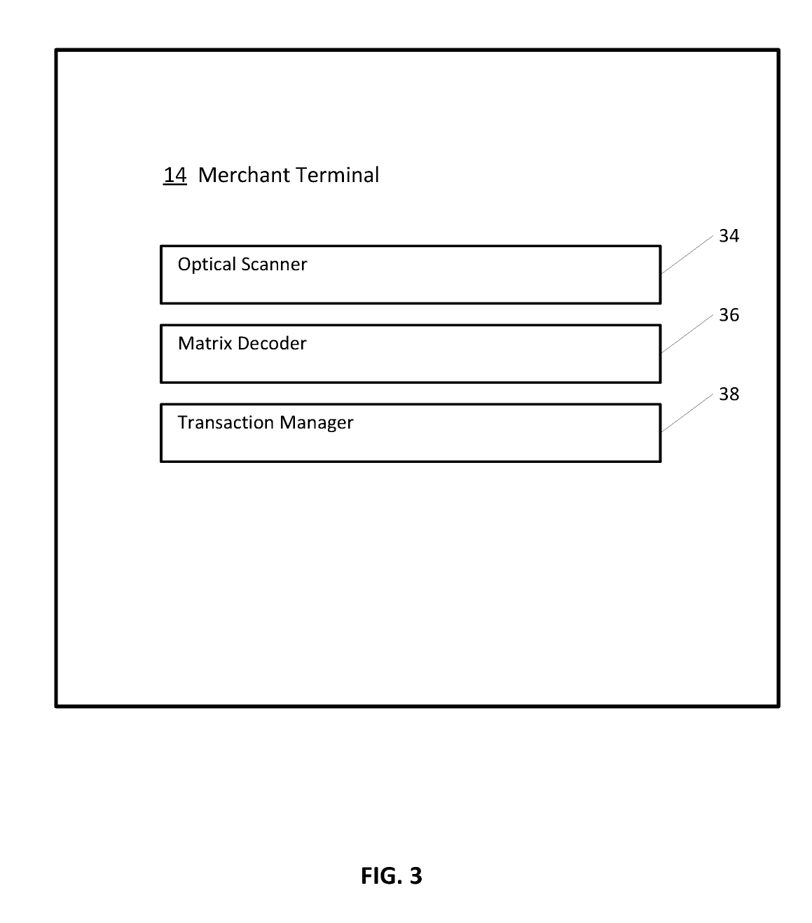

Referring now to FIG. 3, an exemplary merchant terminal 14 includes an optical scanner 34, a matrix decoder 36 and a transaction manager 38. In an embodiment, the merchant terminal 14 includes a dedicated contactless payment terminal that implements a frictionless payment method for transactions involving goods and/or services. The optical scanner 34 scans and reads a matrix barcode, such as a two-dimensional barcode or QR Code®, such as the matrix barcode displayed by the payment manager 26.

The matrix barcode includes information that permits exchange units in a specified consumer account to be exchanged as payment for goods or services from the merchant. The matrix decoder 36 decodes the matrix barcode to access the information. Thus, the merchant terminal 14 allows exchange units to be used as payment for goods or services. In an embodiment, the merchant terminal 14 requires manual input of the price of the goods or services to initiate the purchase transaction. In another embodiment, the price of the goods or services is scanned from the matrix barcode.

The transaction manager 38 sends the price and payment information to the exchange unit dispenser 16 for authorization. Upon receiving authorization from the exchange unit dispenser 16, the transaction manager 38 finalizes the purchase and sale transaction and sends a transaction verification to the exchange unit dispenser 16. In an embodiment, the transaction manager 38 prepares and prints a receipt for the transaction. For example, the receipt may include the transaction amount and the consumer account balance in the local currency of the merchant terminal 14 and/or the base currency of the personal exchange device 12.

An alternative embodiment of the merchant terminal 14 includes a display screen 40. The transaction manager 38 optionally generates and displays a matrix barcode, such as a two-dimensional barcode or QR Code®, including price information and other description information. Referring again to FIG. 2, an alternative embodiment of the personal exchange device 12 can include an optional optical scanner 42 to read the matrix barcode displayed by the merchant terminal 14 and an optional matrix decoder 44 to decode the matrix barcode and access the information.

In an alternative embodiment of the exchange management system 10, the personal exchange device 12 and the merchant terminal 14 optionally implement a near-field communication (NFC) protocol that permits the two devices placed within relatively near proximity of one another to exchange data by way of two-way radio frequency (RF) wireless transmissions. In this example each the personal exchange device 12 and the merchant terminal 14 contains a near-field communication chip and a secure element (SE) chip.

In some embodiments, the personal exchange device 12 does not required an internet connection to perform transactions. For example, the application can save information to be downloaded subsequent to completion of the transaction.

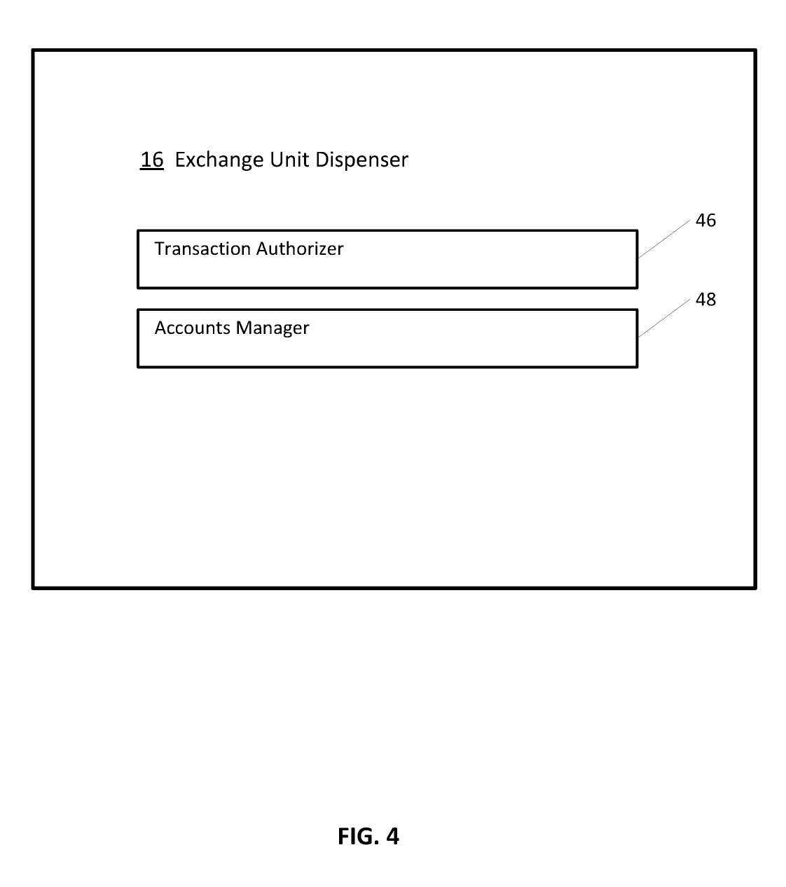

Referring now to FIG. 4, an exemplary exchange unit dispenser 16 includes a transaction authorizer 46 and an accounts manager 48. The exchange unit dispenser 16 acts as a central repository and clearinghouse for the exchange management system 10. In an embodiment all communications between the exchange unit dispenser 16 and the personal exchange device 12 or the merchant terminal 14 are protected by data encryption, for example, using transport layer security (TLS) or secure sockets layer (SSL) technology. Consumer and merchant account data is encrypted and stored on secure servers, including web servers and database servers, housed and maintained in secure locations. Internet access is restricted and protected by multiple firewalls and password protection.

The transaction authorizer 46 receives a transaction request including price and payment information from the personal exchange device 12 or the merchant terminal 14. The information includes an identifier for a consumer account registered by the user of the personal exchange device 12 and a merchant account registered by the entity with the merchant terminal 14. The transaction authorizer 46 ascertains that the current balance in the indicated consumer account is equal or greater than the requested transaction amount. The transaction authorizer 46 also verifies that the debit balance in the indicated merchant account is equal or greater than the transaction amount. If the balances are both sufficient to support the transaction, and the consumer and merchant accounts are in good standing, the transaction authorizer 46 provides an authorization to the personal exchange device 12 and/or the merchant terminal 14.

The accounts manager 48 administers consumer and merchant accounts at the exchange unit dispenser 16. For example, in an embodiment the accounts manager 48 opens new consumer accounts and creates a user profile upon receiving a request from users that have downloaded a consumer application program to a personal exchange device 12. In an embodiment, the accounts manager 48 is configured to automatically debit a merchant account whenever the account balance drops below a predetermined number of exchange units. For example, the accounts manager 48 directs a payment to the financial account of a merchant having a registered merchant terminal and debits additional exchange units to the corresponding merchant account to bring the account to a predetermined renewable balance when the account drops below a predetermined percentage of the renewable balance.

When purchase and sale transactions involving the personal exchange device 12 are authorized, the accounts manager 48 receives an indication of the transaction authorization from the transaction authorizer 46. Upon receipt of the authorization notice, the accounts manager 48 enters a provisional deduction equal to the transaction amount in exchange units in the consumer account and a provisional credit equal to the transaction amount in exchange units in the merchant account.

After the purchase and sale transaction has been finalized by the personal exchange device 12 and the merchant terminal 14, the accounts manager receives a transaction verification from the merchant terminal 14 and/or the personal exchange device 12. Upon receipt of the verification, the accounts manager 48 finalizes the provisional entries in the consumer and merchant accounts and sends a transaction confirmation to the merchant terminal 14 and/or the personal exchange device 12. In an embodiment, the transaction confirmation is included in the transaction authorization.

When purchases and sales are transacted in a country other than that where the personal exchange device 12 has been registered, the accounts manager converts the transaction amount from the local national currency at the location where the purchase and sale transaction occurs into the base currency of the registered personal exchange device 12. In this case, the accounts manager 48 credits the number of exchange units equal to the transaction amount in the local currency of the merchant terminal 14 to the merchant account and deducts the number of exchange units equal to the transaction amount converted to the base currency of the personal exchange device 12 from the consumer account. In an embodiment, no conversion fee or other charge is made to either the consumer account or the merchant account for this service.

The accounts manager 48 makes a record of each transaction in an account history log and tracks the current and historical balance of each consumer or merchant account. After each transaction, or when requested, the accounts manager 48 prepares and sends a record of the current balance in exchange units in terms of the base currency for consumer accounts registered with a personal exchange device 12 or in terms of the local currency for merchant accounts registered with a merchant terminal 14. In an embodiment, the accounts manager 48 sends a low balance alert to a personal exchange device 12 when the relevant consumer account balance drops below a predetermined level.

In an alternative embodiment, the accounts manager 48 sends a transaction confirmation to the merchant terminal 14, which generates a matrix barcode encoding the confirmation information that is read by the personal exchange device 12. In another alternative embodiment, the accounts manager 48 sends a transaction confirmation to the personal exchange device 12, which generates a matrix barcode encoding the confirmation information that is read by the merchant terminal 14.

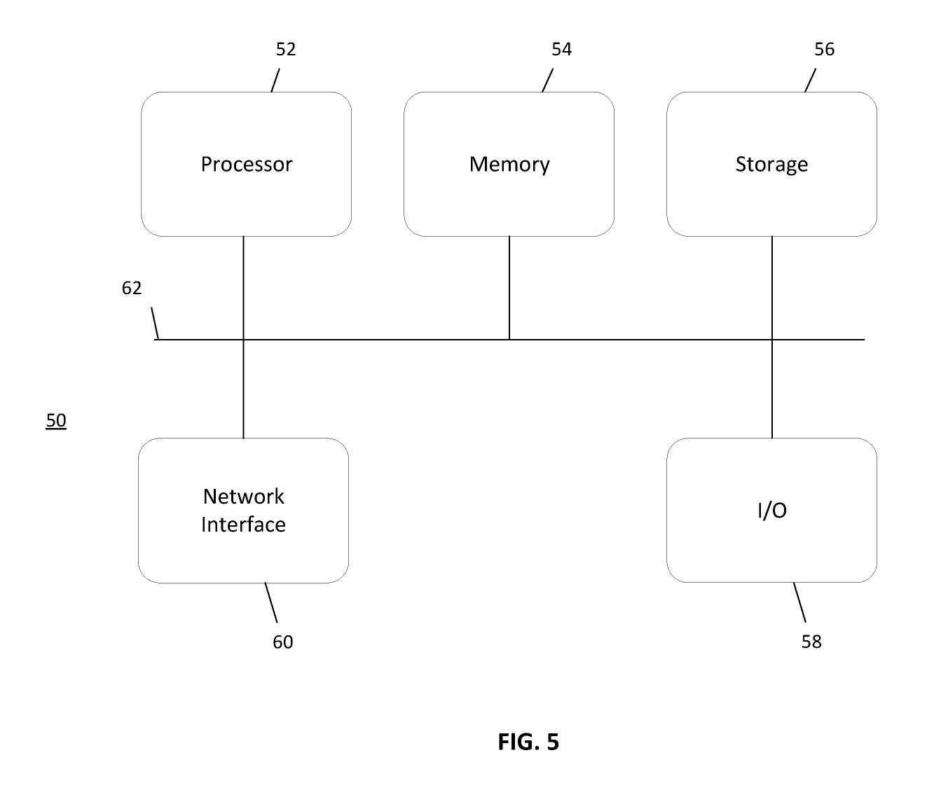

As illustrated in FIG. 5, an exemplary general computing device 50 that can be employed in the exchange management system 10 of FIG. 1 includes a processor 52, a memory 54, storage 56, an input/output device (I/O) 58, and a network interface 60. The various components of the computing device 50 are coupled by a local data link 62, which in various embodiments incorporates, for example, an address bus, a data bus, a serial bus, a parallel bus, a storage bus, or any combination of these.

The computing device 50 can be used, for example, to implement the functions of the components of the exchange management system 10 of FIG. 1, such as the personal exchange device 12, the merchant terminal 14 or the exchange unit dispenser 16. In various embodiments, the computing device 50 can include, for example, a mobile phone, cell phone, smartphone, personal computer (PC), server, workstation, mainframe, specialized or application-specific computing device. Programming code, such as source code, object code or executable code, stored on a computer-readable medium, such as the storage 56 or a peripheral storage component coupled to the computing device 50, can be loaded into the memory 54 and executed by the processor 52 in order to perform the functions of the exchange management system 10.

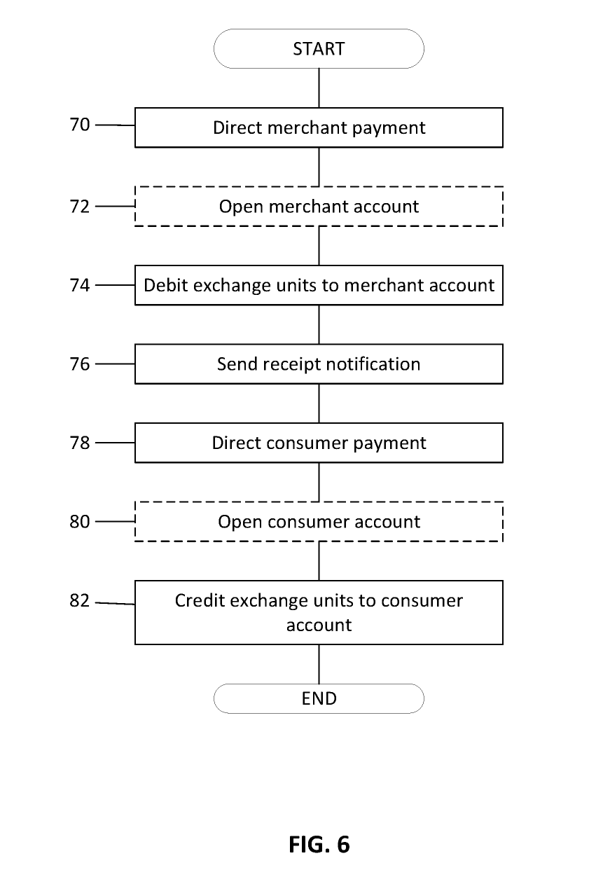

Referring now to FIG. 6, an exemplary process flow is illustrated that may be performed, for example, by the exchange management system 10 of FIG. 1 to implement an embodiment of the method described in this disclosure for managing electronic exchange units to facilitate exchange unit disbursements. The process begins at block 70, where a merchant payment is directed by an exchange unit dispenser to a financial account of a merchant for future bulk goods and/or services. In block 72, a new merchant account is registered to the merchant by the exchange unit dispenser and, in block 74, a number of exchange units are debited to the merchant account, creating a negative merchant account balance. The exchange unit dispenser sends a receipt notification to the merchant terminal memorializing the merchant payment, in block 76.

The number of exchange units debited to the merchant account may be greater than the amount of the merchant payment in terms of a local currency where the merchant transacts business. Any difference between the debited number of exchange units and the amount of the merchant payment represents a merchant discount, whereby the merchant agrees to provide a larger value of future goods and/or services in terms of exchange units based on the local currency than the amount of the merchant payment. For example, a merchant doing business in the United States may receive a payment of ninety dollars and promise to provide future goods nominally valued at one hundred dollars.

In block 78, a domestic personal exchange device directs a consumer payment from a consumer financial account of a consumer to a financial account connected with the exchange unit dispenser. A new consumer account is registered to the consumer, in block 80, by the exchange unit dispenser and, in block 82, a number of exchange units are credited to the consumer account, creating a positive consumer account balance.

The amount of the consumer payment in terms of a base currency where the consumer account is registered may be greater than the number of exchange units credited to the consumer account. Any difference between the amount of the consumer payment and the credited number of exchange units represents a consumer discount. For example, a personal exchange device connected with a consumer account registered in the United States may direct a payment of ninety-five dollars for one hundred exchange units.

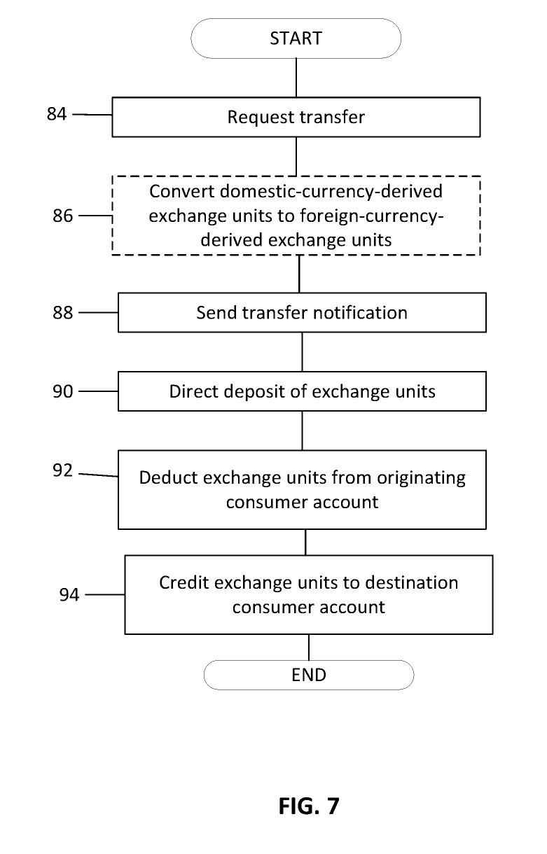

Referring to FIG. 7, an exemplary process flow is illustrated that may be performed, for example, by the exchange management system 10 of FIG. 1 to implement an embodiment of the method described in this disclosure for managing electronic exchange units to transfer exchange units between consumer accounts. The process begins at block 84, where the originating personal exchange device requests a transfer of exchange units to a another consumer account, such as a consumer account registered in a different country with a foreign personal exchange device. For example, the U.S.-based personal exchange device directs a transfer of a specified number of exchange units to a consumer account registered in Viet Nam.

In response to the request, the exchange unit dispenser optionally converts the exchange units derived from the domestic currency, in block 86, to exchange units based on the foreign currency. For example, the exchange units based on U.S. dollars (USD) are converted to exchange units derived from Vietnamese dong (VND) based on the current applicable currency exchange rate. (For example, when the exchange rate between U.S. dollars and Vietnamese dong is 22,000 VND/USD, the one hundred exchange units based on USD are converted to 2,200,000 exchange units based on VND.)

In block 88, the exchange unit dispenser prepares and sends a notification to the foreign personal exchange device regarding the requested transfer and, in block 90, the foreign personal exchange device directs the deposit of the exchange unit in the foreign consumer account.

In block 92, the exchange unit dispenser deducts the requested number of exchange units from the U.S. consumer account and, in block 94, the exchange unit dispenser credits the equivalent number of converted exchange units to the destination consumer account. For example, the exchange unit dispenser deducts one hundred exchange units form the U.S.-based consumer account and credits 2,200,000 exchange units to the Viet Nam-based consumer account.

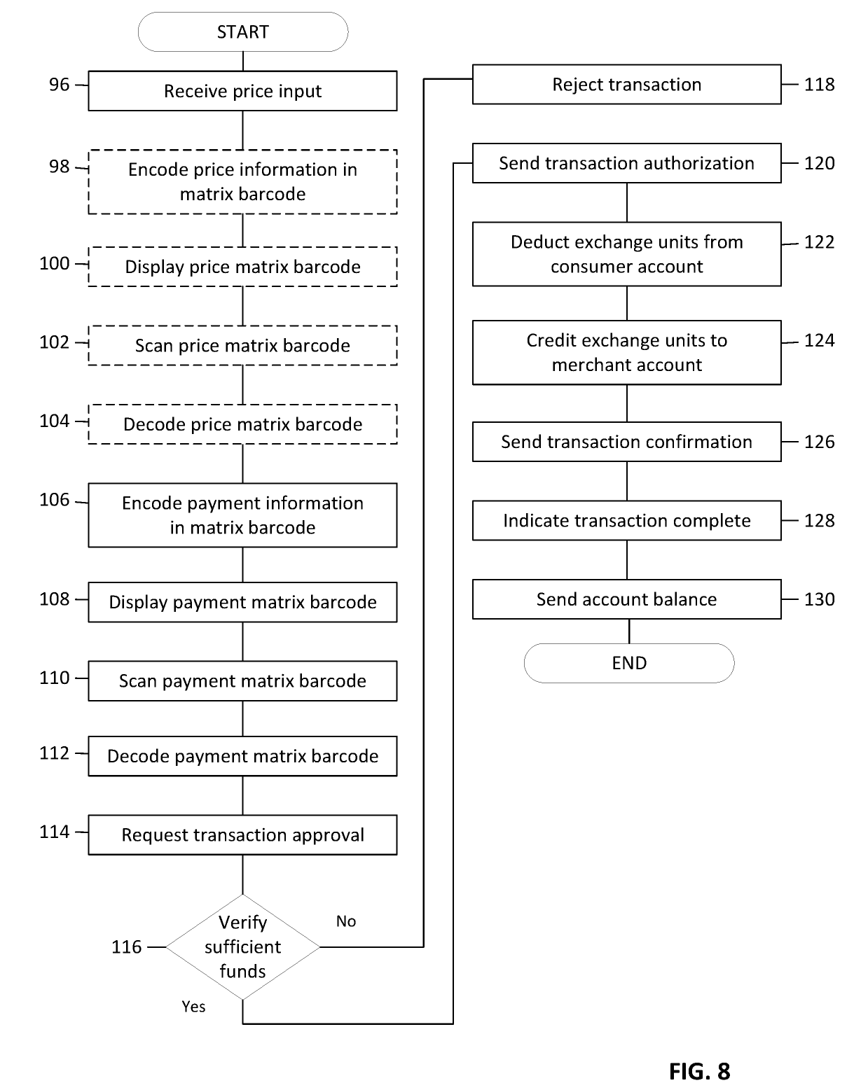

Referring to FIG. 8, an exemplary process flow is illustrated that may be performed, for example, by the exchange management system 10 of FIG. 1 to implement an embodiment of the method described in this disclosure for managing electronic exchange units to facilitate point-of-sale (POS) exchanges between consumers and merchants. The process begins at block 96, where a merchant terminal receives a price, for example, as manual input, scanned input from a barcode tag, or wireless communication from a radio-frequency identification (RFID) tag, representing the nominal value of goods and/or services to be provided by the merchant to the consumer. The merchant terminal optionally generates a merchant matrix barcode, in block 98, encoding the price along with additional optional information regarding the tentative transaction and, in block 100, the merchant terminal optionally displays the matrix barcode or grid on a display screen.

In block 102, the personal exchange device optically scans the matrix barcode from the merchant terminal display screen. For example, the foreign personal exchange device may scan a merchant terminal registered in Viet Nam. The personal exchange device decodes the matrix barcode, in block 104, in order to ascertain the price and optional information regarding the tentative transaction. The personal exchange device generates a payment matrix barcode, in block 106, encoding payment information, including, for example, the payment amount, a financial account identifier, and additional optional information regarding the transaction. The personal exchange device displays the matrix barcode, in block 108, on a display screen.

In block 110, the merchant terminal optically scans the matrix barcode from the personal exchange device display screen and, in block 112, the merchant terminal decodes the matrix barcode in order to acquire the payment information. In block 114, the merchant terminal sends a request for approval of the transaction to the exchange unit dispenser.

Upon receiving the request for approval, the exchange unit dispenser verifies that the foreign consumer account is valid and that sufficient funds for the transaction currently exist in the account, in block 116. If there are not sufficient funds in the account, the exchange unit dispenser rejects the tentative transaction, in block 118. Otherwise, if there are sufficient funds in the account, the exchange unit dispenser sends an authorization for the transaction to the merchant terminal, in block 120.

In block 122, the exchange unit dispenser deducts the number of exchange units equaling the transaction amount from the foreign consumer account and, in block 124, the exchange unit dispenser credits the number of converted exchange units equaling the transaction amount to the foreign merchant account. For example, the transaction amount is 2,200,000 VND and the exchange unit dispenser deducts 2,200,000 exchange units from the Viet Nam-based consumer account and credits 2,200,000 exchange units to the Viet Nam-based merchant account.

In block 126, the exchange unit dispenser sends a transaction confirmation to the merchant terminal and, optionally, to the personal exchange device. Upon receiving the confirmation, the merchant terminal optionally provides an indication, in block 128, that the transaction has been completed, such as printing out a receipt memorializing the transaction, displaying a textual confirmation message on a display screen, or presenting an authorization signal, such as illuminating a light.

The exchange unit dispenser sends an account balance notice to the merchant terminal or, optionally, to the personal exchange device, in block 130. For example, the balance notice is sent upon request or when the corresponding account drops below a predetermined minimum balance.

Components shown with dashed lines in FIGS. 6-8 are optional items that may not be included in all implementations. The systems and methods described herein can offer advantages such as providing a generalized customer discount in addition to any other sales or special offers on all purchases transacted in exchange units. Merchants can further benefit from group advertising provided for by the exchange unit dispenser on behalf of all participating merchants.

Aspects of this disclosure are described herein with reference to flowchart illustrations or block diagrams, in which each block or any combination of blocks can be implemented by computer program instructions. The instructions may be provided to a processor of a general purpose computer, special purpose computer, or other programmable data processing apparatus to effectuate a machine or article of manufacture, and when executed by the processor the instructions create means for implementing the functions, acts or events specified in each block or combination of blocks in the diagrams.

In this regard, each block in the flowchart or block diagrams may correspond to a module, segment, or portion of code that includes one or more executable instructions for implementing the specified logical function(s). It should also be noted that, in some alternative implementations, the functionality associated with any block may occur out of the order noted in the figures. For example, two blocks shown in succession may, in fact, be executed substantially concurrently, or blocks may sometimes be executed in reverse order.

A person of ordinary skill in the art will appreciate that aspects of this disclosure may be embodied as a device, system, method or computer program product. Accordingly, aspects of this disclosure, generally referred to herein as circuits, modules, components or systems, or the like, may be embodied in hardware, in software (including source code, object code, assembly code, machine code, micro-code, resident software, firmware, etc.), or in any combination of software and hardware, including computer program products embodied in a computer-readable medium having computer-readable program code embodied thereon.

It will be understood that various modifications may be made. For example, useful results still could be achieved if steps of the disclosed techniques were performed in a different order, and/or if components in the disclosed systems were combined in a different manner and/or replaced or supplemented by other components. Accordingly, other implementations are within the scope of the following claims.

What is claimed is:

1. A device for managing exchange unit transfers between consumers and merchants, comprising:
a memory that stores machine instructions; and
a processor coupled to the memory that executes the machine instructions to direct a consumer payment from a financial account associated with the device to an exchange unit dispenser, receive a balance of exchange units corresponding to an exchange account associated with the device, encode information associated with the device, and transmit the encoded information to a merchant terminal, wherein the consumer payment is denominated in a first national currency corresponding to a first location associated with the device, the balance of exchange units based on the first national currency, and the balance of exchange units is greater than the consumer payment.

2. The device of claim 1, wherein the encoded information includes at least one selected from the group comprising a first identifier associated with the device, a second identifier associated with the financial account, a price, and a payment.

3. The device of claim 1, wherein the processor further executes the machine instructions to send a request associated with a tentative transaction associated with the merchant matrix barcode to an authorizer and receive an authorization in response to the request.

4. The device of claim 1, wherein the processor further executes the machine instructions to receive a transaction confirmation from at least one selected from the group comprising the exchange unit dispenser and the merchant terminal and display a confirmation message.

5. The device of claim 1, wherein the processor further executes the machine instructions to receive a notification associated with a transfer of a quantity of exchange units from a personal exchange device and direct the quantity of exchange units to the financial account, the transfer directed by the personal exchange device in a second national currency corresponding to a second location associated with the personal exchange device and received by the device in the first national currency.

6. The device of claim 1, wherein the processor further executes the machine instructions to generate a matrix barcode encoding the information associated with the device, and display the matrix barcode.

7. The device of claim 1, wherein the processor further executes the machine instructions to scan a merchant matrix barcode and decode the merchant matrix barcode to acquire information associated with the merchant terminal.

8. A terminal for managing exchange unit transfers between consumers and merchants, comprising:
a non-transitory, computer-readable storage medium encoded with instructions adapted to be executed by a processor to implement:
directing a merchant payment from an exchange unit dispenser to a financial account associated with the terminal, the merchant payment denominated in a national currency corresponding to a location associated with the terminal;
receiving a debit balance of exchange units corresponding to an exchange account associated with the terminal, the debit balance of exchange units being based on the national currency and greater than the merchant payment;
receiving an input including a price associated with goods and/or services;
receiving encoded information from a personal exchange device;
decoding the encoded information to acquire information associated with the personal exchange device;
sending a request associated with a tentative transaction associated with the personal exchange device to an authorizer; and
receiving an authorization in response to the request.

9. The terminal of claim 8, wherein the information associated with the personal exchange device includes at least one selected from the group comprising a first identifier associated with the personal exchange device, a second identifier associated with a financial account associated with the personal exchange device, the price, and a payment, and the request includes at least a part of the information.

10. The terminal of claim 8, wherein the instructions are further adapted to implement receiving a notification from an exchange unit dispenser, the notification corresponding to a merchant payment to the exchange unit dispenser.

11. The terminal of claim 8, wherein the instructions are further adapted to implement:
receiving a transaction confirmation from at least one selected from the group comprising the exchange unit dispenser and a personal exchange device; and
performing at least one selected from the group comprising presenting an authorization signal, displaying a confirmation message, or printing a receipt.

12. The terminal of claim 8, wherein the instructions are further adapted to implement scanning a matrix barcode from a personal exchange device, and decoding the encoded information includes decoding the matrix barcode.

13. The terminal of claim 8, wherein the instructions are further adapted to implement generating a merchant matrix barcode encoding information associated with a merchant account and display the merchant matrix barcode.

14. The terminal of claim 13, wherein the instructions are further adapted to implement encoding a transaction confirmation in the merchant matrix barcode.

15. A method of managing exchange unit transfers between consumers and merchants, comprising:
directing a merchant payment to a financial account associated with a merchant terminal;
debiting a number of exchange units to a merchant account associated with the merchant terminal;
receiving one or more consumer payments directed by one or more personal exchange devices, the one or more consumer payments totaling more than the merchant payment;
adding the number of exchange units to one or more consumer accounts associated with the one or more personal exchange devices;
receiving at least one request associated with at least one tentative transaction associated with the merchant terminal and the one or more personal exchange devices; and
in response to receiving the at least one request:
deducting the number of exchange units from the one or more consumer accounts; and
crediting the number of exchange units to the merchant account.

16. The method of claim 15, further comprising receiving a request associated with a tentative transaction associated with the merchant terminal and a personal exchange device of the one or more personal exchange devices and sending an authorization in response to the request.

17. The method of claim 15, wherein the at least one request includes at least one selected from the group comprising a first identifier associated with the device, a second identifier associated with the financial account, a price, and a payment.

18. The method of claim 15, wherein the authorization includes a transaction confirmation.

19. The method of claim 15, further comprising sending at least one transaction confirmation to at least one selected from the group comprising the merchant terminal and the one or more personal exchange devices.

20. The method of claim 15, wherein the number of exchange units is based on the at least one tentative transaction denominated in a national currency corresponding to a location associated with the merchant terminal.
